(19) United States
(12) Patent Application Publication
(10) Pub. No.: US 2026/0158371 A1
(43) Pub. Date: Jun. 11, 2026

(54) APPARATUS AND METHOD FOR INDUCING MOTION PERCEPTION

(71) Applicant: Sony Group Corporation, Tokyo (JP)

(72) Inventors: Stefan UHLICH, Stuttgart (DE); Diederik Paul MOEYS, Zurich (CH); Dunai Fuentes HITOS, Zurich (CH); Justinas MISEIKIS, Zurich (CH); Lev MARKHASIN, Stuttgart (DE)

(21) Appl. No.: 19/179,248

(22) Filed: Apr. 15, 2025

(30) Foreign Application Priority Data
Apr. 17, 2024 (EP) 24170759

(51) Int. Cl. A63F 13/211; G06F 3/01

(52) U.S. Cl. CPC A63F 13/211; G06F 3/011; G06F 3/016

(57) ABSTRACT

An apparatus for inducing motion perception. The apparatus includes processing circuitry configured to receive data indicating a target motion to be perceived by a user. The processing circuitry is further configured to control an object to change a physical property of the object based on the target motion to induce perception of the target motion by the user. The object is arranged for interaction with the user.

### RELATED APPLICATION DATA

The present disclosure claims the benefit of European Application No. 24170759, filed Apr. 17, 2024, the disclosure of which is incorporated herein by reference in its entirety.

### FIELD

The present disclosure relates to manipulating the motion perception of users. In particular, examples of the present disclosure relate to an apparatus and a method for inducing motion perception.

### BACKGROUND

Conventional Virtual Reality (VR) motion simulation methods involve applying electrical signals to the vestibular system to induce a sense of motion. However, this approach is hindered by variations in individual responses, making it challenging to apply a universal signal for specific motions. To overcome this, existing systems often just introduce a “noise” signal to the vestibular system to mitigate motion sickness in VR experiences where visual input mismatches signals perceived by the vestibular system.

Hence, there may be a demand for improved induction of motion perception.

### SUMMARY

This demand is met by an apparatus and a method for inducing motion perception, a nontransitory machine-readable medium and a program in accordance with the independent claims. Advantageous embodiments are defined by the dependent claims.

According to a first aspect, the present disclosure provides an apparatus for inducing motion perception. The apparatus comprises processing circuitry configured to receive data indicating a target motion to be perceived by a user. The processing circuitry is further configured to control an object to change a physical property of the object based on the target motion to induce perception of the target motion by the user. The object is arranged for interaction with the user.

According to a second aspect, the present disclosure provides a method for inducing motion perception. The method comprises receiving data indicating a target motion to be perceived by a user. Additionally, the method comprises controlling an object to change a physical property of the object based on the target motion to induce perception of the target motion by the user. The object is arranged for interaction with the user.

According to a third aspect, the present disclosure provides a non-transitory machine-readable medium having stored thereon a program having a program code for performing the method according to the second aspect, when the program is executed on a processor or a programmable hardware.

According to a fourth aspect, the present disclosure provides a program having a program code for performing the method according to the second aspect, when the program is executed on a processor or a programmable hardware.

### BRIEF DESCRIPTION OF THE FIGURES

Some examples of apparatuses and/or methods will be described in the following by way of example only, and with reference to the accompanying figures, in which:

FIG. 1 illustrates an example of an apparatus for inducing motion perception; and

FIG. 2 illustrates a flowchart of an example of a method for inducing motion perception.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

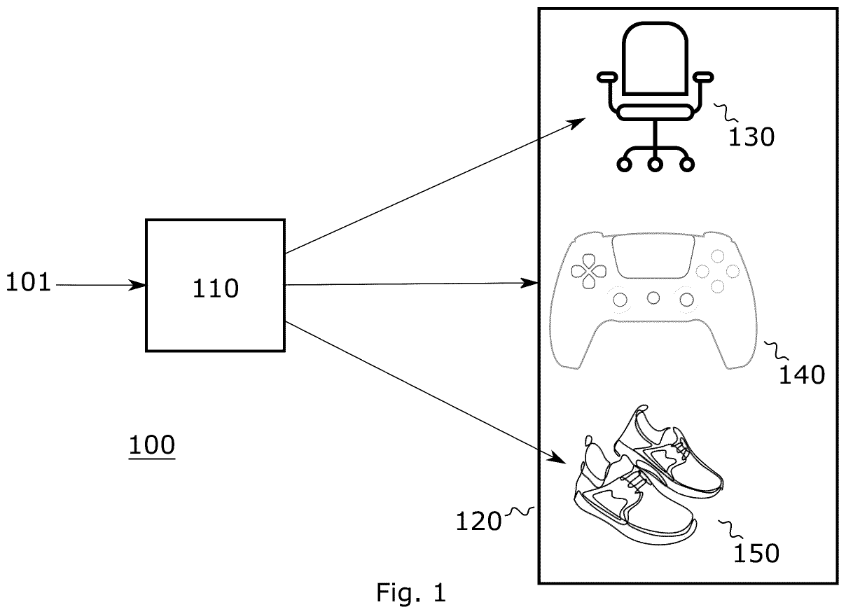

FIG. 1 schematically illustrates an apparatus 100 for inducing motion (movement) perception in a user. In other words, the apparatus 100 is for generating a perception of motion (movement) in the user.

The apparatus comprises processing circuitry 110. For example, the processing circuitry 110 may be a single dedicated processor, a single shared processor, or a plurality of individual processors, some of which or all of which may be shared, a digital signal processor (DSP) hardware, an application specific integrated circuit (ASIC), a system-on-a-chip (SoC) a neuromorphic processor or a field programmable gate array (FPGA). The processing circuitry 100 may optionally be coupled to, e.g., memory such as read only memory (ROM) for storing software, random access memory (RAM) and/or non-volatile memory. For example, the apparatus 100 may comprise memory configured to store instructions, which when executed by the processing circuitry 110, cause the processing circuitry 110 to perform the steps and methods described herein.

The processing circuitry 110 is configured to receive and process data 101 indicating a target (desired) motion to be perceived by the user. The target motion is motion (e.g., in a specific direction) that the user is (supposed) to perceive. For example, the target motion may be a change in position and/or orientation (e.g., along a particular path or trajectory) the user is (supposed) to perceive. The target motion may be manifold. The target motion may, e.g., be acceleration of the user, deceleration of the user, falling of the user, tilting of the user, stumbling of the user, moving forward of the user, moving backward of the user, moving sideward of the user, rotation of the user, jumping of the user, or any combination thereof.

The data 101 may be provided from various sources. For example, the data 101 may be received from an external device generating and optionally further outputting a VR environment to the user. For example, the data 101 may be received from a server, a computer, a game console or a VR headset. The apparatus 100 may optionally comprise a receiver or a transceiver (not illustrated in FIG. 1) configured for (e.g., wireless or wired) reception of the data 101 from the external device. In other examples, the data 101 may be received from an external device for vertigo treatment or other medical applications to create the impression in the user that the user's body or a part thereof performs a certain motion. However, it is to be noted that the present application is not limited to the aforementioned examples.

The processing circuitry 110 is configured to control an object 120 to change a physical property of the object 120 (i.e., an object property) based on the target motion to induce perception of the target motion by the user. For example, the processing circuitry 110 may generate a control signal or control data for the object 120 and supply it to the object 120. Based on the control signal or control data, the object 120 changes the physical property of the object 120.

The object 120 is a physical object, i.e., an object that occupies space and has mass in the real (physical) world. The object 120 is arranged for interaction with the user. In other words, the object is structured in a way to interact or to enable interaction with the user. The object 120 may be manifold. For example, the object 120 may be one of a chair 130, a game controller 140 and a pair of shoes 150. However, it is to be noted that the present disclosure is not limited to the foregoing examples. The physical property of the object 120 may be any property (characteristic, attribute) of the object 120 that can be changed without changing the chemical composition or identity (i.e., its unique characteristics or qualities that distinguish it from other objects) of the object. The physical property of the object 120 may be a property of the entire object 120 or of a part of the object 120. In particular, the physical property of the object 120 may be any property of the object 120 that can be changed without changing a position of the object 120 in space. For example, the physical property of the object 120 may be a stiffness (softness) of the object 120, a color of the object 120, a mass distribution of the object 120, a temperature of the object 120, or any combination thereof.

Human beings are highly sensitive to changes of physical properties of objects, even to small changes. Over time, human beings learn that certain changes in object properties go hand in hand with certain (specific) motions or are caused by them. Accordingly, the user associates certain changes in object properties with certain (specific) motions. This means that the user assumes, based on their experience, that a certain change in a physical property of an object is associated with (connected to, related to, paired with) a certain motion. In other words, the user compares the observed physical property of an object with an expected physical property of an object and associates a discrepancy between the observed and the expected physical property with motion. By changing the physical property of the object 120 based on the target motion, the apparatus 100 exploits the user's sensitivity to changes of physical properties of objects and the user's learned association of changes in object properties with motions. The user is able sense (observe) the property of the object 120 when interacting with the object 120. Accordingly, the processing circuitry 110 may be configured to control the object 120 to change the physical property such that the motion perceived by the user due to the change of the physical property follows (adjusts with, aligns with) the target motion. The apparatus 100 allows to stimulate motion perception without directly affecting the user's vestibular system. Compared to conventional vestibular stimulation, the apparatus 100 eliminates the need to inject signals into the vestibular system, ensuring a non-intrusive and risk-free experience for users. The proposed technology further caters to individual differences, offering a more adaptable and user-friendly solution for motion simulation (e.g., in virtual environments).

In the following, various examples will be described in greater detail to highlight the induction of motion perception according to the present disclosure.

As indicated above, the physical property may be a stiffness (or softness) of a surface of the object. The stiffness indicates how rigid or flexible the surface is. In other words, it describes how much the surface resists bending, stretching, or compressing under an external load. The surface of the object may generally be any part of the object that comes or can come into direct contact with user when the user interacts with the object. Changing the stiffness of a surface allows to induce the perception of motion as the reduction of stiffness or increase of stiffness may be associated by the user with a motion of the object relative to the user.

For example, for controlling the object 120 to change the stiffness of the surface of the object 120, the processing circuitry 110 may be configured to control the object 120 to change a pressure in a volume mechanically coupled to the surface of the object 120. The surface of the object may, e.g., be a (direct, immediate, physical) boundary of the volume (i.e., at least part of the volume's boundary is/forms the surface) or be mechanically coupled to a boundary of the volume (e.g., the volume may be attached to the surface) such that the change in pressure results in a change in stiffness of the surface. The amount of change and/or the rate of change of the stiffness may be determined by the processing circuity 110 based on the target motion. For example, the processing circuitry 110 may control the object 120 to increase or decrease an amount of fluid (e.g., water) or gas (e.g., air) in the volume for changing the stiffness of the surface of the object 120. The rate of increase or decrease of the fluid or gas and/or the amount of increase or decrease of the fluid or gas may be determined by the processing circuitry 110 based on the target motion. The space occupied by the volume may be kept constant or be changed when changing the pressure in the volume. For changing the stiffness of the object 120, the processing circuitry 110 may, e.g., control a pneumatic piston of the object 120 to change an air pressure. Increasing the air pressure will make the surface stiffer while reducing the air pressure will make it softer.

As indicated above, the object 120 may be a chair such as the chair 130 illustrated in FIG. 1. In general, the chair 130 may be any piece of furniture designed for seating a person. The chair 130 comprises a backrest and a seat supported by legs or a pedestal. Optionally, the chair 130 may comprise further elements such as armrests.

In case the target motion is falling or tilting of the user, the processing circuitry 110 may be configured to control the chair 130 to reduce a stiffness of at least one armrest thereof. The processing circuitry 110 may control the chair 130 to reduce the stiffness of the respective entire armrest or a part thereof. For example, if the target motion is falling (e.g., a sudden or discontinuous move downwards), the processing circuitry 110 may configured to control the chair 130 to (e.g., swiftly or instantly) reduce the stiffness of both of its armrests. By making both armrests softer, the user experiences a sensation similar to falling. In other examples, if the target motion is tilting (e.g., an uneven downward motion/rotation/change in orientation in a particular direction with respect to the direction the user is facing), the processing circuitry 110 may be configured to control, based on the target motion, the chair 130 to adjust the stiffnesses of its armrests such that the armrests have an uneven stiffness along the target motion. When the user is leaning towards one side, the user will recognize that the stiffness has changed to what he “remembers” from the last time and he has the feeling of falling to one side. For example, if the target motion is falling or tilting of the user to the left side, the processing circuitry 110 may control the chair 130 to adjust the stiffnesses of its armrests such that the left armrest is softer (i.e., less stiff) than the right armrest. The user will associate the difference in stiffness with falling or tilting to the left side. For example, in case the user is playing a car racing video game, the user is likely to automatically move to the side the user has to steer the car. When the car takes a curve, this “sensation” can be given to the user by changing the stiffness of the corresponding armrest. In case the user observes a plane flying closely and tilting (e.g., in a VR environment or in a video game), reducing the armrest's stiffness may convey the feeling of tilting or falling. In both cases, the external circuitry hosting the car racing video game or the VR environment or video game presenting the airplane may provide the data 101 indicating the target motion to the apparatus 100.

In case the target motion is acceleration or deceleration of the user, the processing circuitry 110 may be configured to control the chair 130 to change a stiffness of a backrest thereof. Altering the backrest's stiffness allows to mimic the sensation of acceleration or deceleration (e.g., in a forward direction). When the stiffness of the backrest is reduced (i.e., the backrest becomes less stiff), the user feels being pushed back like when the user's body is accelerated (e.g., when accelerating a car). On the other hand, when the stiffness of the backrest is increased (i.e., the backrest becomes stiffer), the user feels a forward thrust similar to the forward thrust experienced during deceleration (e.g., when braking a car). For example, in case the user is playing a car racing video game, changing the backrest's stiffness allows to mimic the sensation felt by the user when accelerating or decelerating a real car. Accordingly, the feeling of immersion may be improved for the user.

In other examples, the object 120 may be the pair of shoes 150. In these examples, the physical property is a property of the pair of shoes 150. For controlling the pair of shoes 150 to change the property of the pair of shoes 150, the processing circuitry 110 may, e.g., be configured to control at least one shoe of the pair of shoes 150 to change a respective pressure in one or more volumes of the respective shoe. In other words, the physical property may be a stiffness of the shoes or a part thereof. Changing the stiffness of the shoes or parts thereof allows to induce perception of various motions in the user.

For example, if the target motion is stumbling (i.e., tripping or loosing balance while walking), the processing circuitry 110 may be configured to control the pair of shoes 150 to reduce the stiffness of soles of the pair of shoes 150. Accordingly, the user may experience a feeling of “wavering” when moving. For example, each shoe of the pair of shoes 150 may comprise air cushions under the sole and the processing circuitry 110 may control the pair of shoes to release air and make the air cushions very soft such that the user feels the wavering. In case an avatar of the user is stumbling in a VR environment, reducing the stiffness of the soles of the pair of shoes 150 allows to increase the feeling of stumbling and, hence, the feeling of immersion for the user. For example, if an avatar of the user is moving in a first-person view VR game and falling over an obstacle in the VR game. Automatically, once the user visually notices the falling in the VR game, the user will move in the real (physical) world in order to balance. The external device hosting the VR may output the data 101 with the indication that the target motion is stumbling. Accordingly, the processing circuitry 110 may control the pair of shoes 150 to reduce the stiffness of the soles of the pair of shoes 150 (e.g., by reducing the pressure in air cushions under the soles of the shoes) such that when the user makes the next step with the softer shoe soles, the user experiences a sensation of stumbling or falling due to the shoe soles that are softer than expected by the user.

In other examples, if the target motion is falling or tilting, the processing circuitry 110 may be configured to control the pair of shoes 150 to reduce the stiffness of the sole of at least one shoe of the pair of shoes 150. For example, if the target motion is falling, the processing circuitry 110 may be configured to control the pair of shoes 150 to (e.g., swiftly or instantly) reduce the stiffness of both shoes. By making the soles of both shoes softer, the user experiences a sensation similar to falling. In other examples, if target motion is falling or tilting, the processing circuitry 110 may be configured to control, based on the target motion, the pair of shoes 150 to adjust the stiffnesses of soles of the shoes that the two shoes have different stiffnesses along to the falling or tilting direction. For example, if the target motion is falling or tilting of the user to the left side, the processing circuitry 110 may control the pair of shoes 150 to adjust the stiffnesses of the soles such that the sole of the left shoe is softer (i.e., less stiff) than the sole of the right shoe. The user will associate the difference in stiffness with falling or tilting to the left side. Making one shoe sole softer than the other may give the user the feeling of walking on an edge bending.

In other examples, if the target motion is moving forward or backward of the user, the processing circuitry 110 may be configured to control the pair of shoes 150 to change an inclination of the soles of the pair of shoes 150. In other words, the pair of shoes 150 may be controlled to change an angle or slope of the soles of the pair of shoes 150. The pair of shoes 150 may, e.g., be controlled to modify a shape or positioning of the soles to provide a different angle of inclination. For example, the processing circuitry 110 may be configured to control each shoe of the pair of shoes 150 to increase a first volume under the forefoot part of the shoe's sole and decrease a second volume under the heel part of the shoe's sole, or vice versa. Accordingly, the sole may be adjusted to rise (ascend) or fall from the heel part to the forefoot part. Adjusting the sole to fall from the heel part to the forefoot part subtly encourages a forward motion sensation. Analogously, adjusting the sole to rise from the heel part to the forefoot part subtly encourages a backward motion sensation. During a (VR) video game, changing the shape/orientation of the sole (not just the stiffness) may allow to give the user the feeling of moving forward or backward and, hence, increase the feeling of immersion.

In some examples, the object 120 may be the game controller (hand-held controller) 140. The game controller 140 is an input device used to interact with video games and control gameplay on game consoles, computers, or mobile devices. In these examples, the physical property is a property of the game controller 140.

For example, the processing circuitry 110 may be configured to control the game controller 140 to change a center of mass of the game controller 140 in accordance with the target motion. For controlling the game controller 140 to change the center of mass of the game controller 140, the processing circuitry 110 may, e.g., be configured to control a motor of the game controller 140 to change a position of a movable mass of the game controller 140 in accordance with the target motion. The motor and the movable mass may be integrated into the game controller 140 (e.g., be arranged inside a housing of the game controller 140) or be (e.g., removably) attached to the game controller 140. By changing the center of mass of the game controller 140 in accordance with the target motion, a feeling of movement along the target motion may be induced in the user. For example, in case the user plays a car race video game, the user is likely to automatically move the game controller into the direction the car is/should be driving in the video game (most users tend to move their upper body and, hence, the game controller 140 while playing car race video games). The user will recognize the changed balance of the game controller 140 caused by the change of the game controller 140's center of mass. The changed balance of the game controller 140 gives the user a feeling of motion. For example, if the car is driving to the right in the car race video game, the target motion may be motion to the right. The external device hosting the video game may provide the data 101 to indicate that the target motion is motion to the right. Accordingly, the processing circuitry 100 may control the game controller 140 to change the center of mass of the game controller 140 to the right (e.g., by moving the movable mass of the game controller 140 to the right) such that the user feels a motion to the right.

In other examples, the processing circuitry 110 may be configured to control the game controller 140 to change a color of the game controller 140 in accordance with the target motion. For example, the game controller 140 may comprise a plurality of light-emitting elements (e.g., Light-Emitting Diodes, LEDs) capable of emitting light of different colors such that the color of the game controller may be adjusted by switching on and off different ones of the plurality of light-emitting elements. Accordingly, for changing the color of the game controller 140, the processing circuitry 110 may control the game controller 140 to switch on and off different ones of the plurality of light-emitting elements of the game controller 140. For example, the game controller 140's color may be changed dynamically to reflect motions within a video game. For example, when a jump over an obstacle occurs in the video game, the controller's color may be changed from the ground color to the obstacle's color and then back to the ground color. The target motion indicated by the data 101 may be the jump over obstacle. The data 101 may indicate further properties such as the colors of the ground and the obstacle. Accordingly, the game controller 140 may be controlled to show a color gradient which changes and such mimics a forward motion to represent the user's action in the video game. Similarly, when an avatar of the user rotates in the video game, the target motion indicated by the data 101 may be or correspond to the avatar rotation and the game controller 140 may be controlled to show a color gradient which changes according to the colors of the avatar's surrounding in the video game and such mimics the rotation to represent the user's action in the video game. The data 101 may indicate further properties such as the colors of the avatar's surrounding in the video game. Users often look down at the game controller 140 in their hand. Changing the color of the game controller 140 may allow to mimic the experience of looking down while jumping over the obstacle, thereby enhancing the sensation of movement.

In some examples, the processing circuitry 110 may be configured to control the game controller 140 to display a representation of the feet of the user (e.g., an animated representation), wherein a movement of the feet is in accordance with the target motion. For example, the game controller 140 may comprise a display for displaying the representation of feet of the user. Users often look down at the game controller 140 in their hand. The display of the representation of feet of the user by the game controller 140 may allow to mimic the natural view of the user's feet when walking, thus enriching the sensation of movement. For example, if an avatar of the user is moving in a video game, the external device hosting the video game may provide the data 101 to indicate the current moving direction of the avatar in the video game as the target motion. Accordingly, the processing circuitry 110 may control the game controller 140 to display the representation of feet of the user synchronized with the in-game movement, enhancing the realism of virtual locomotion.

As is evident from the above examples, the present technology allows to create the sensation of motion for users using (e.g., subtle) changes of physical parameters of objects the user interacts with. This allows to provide user with perception of motion without directly stimulating their vestibular system and without the need to physically move them.

Examples of the present disclosure not only relate to the apparatus 100 but also to systems comprising the apparatus 100 and the object 120. As described above, the object 120 may, e.g., be the chair 130, the game controller 140 or the pair of shoes 150.

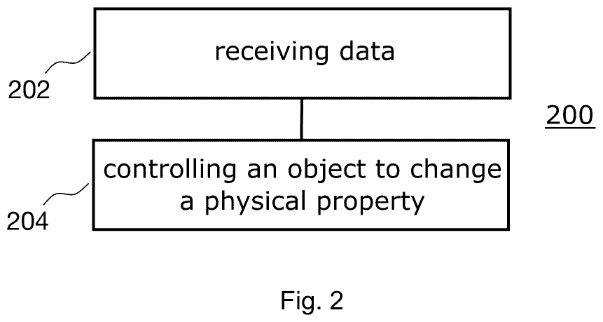

For further highlighting the induction of motion perception described above, FIG. 2 illustrates a flowchart of a method 200 for inducing motion perception. The method 200 comprises receiving 202 data indicating a target motion to be perceived by a user. Additionally, the method 200 comprises controlling 204 an object to change a physical property of the object based on the target motion to induce perception of the target motion by the user. The object is arranged for interaction with the user. Analogously to what is described above, the method 200 provides improved induction of motion perception.

More details and aspects of the method 200 are explained in connection with the proposed technique or one or more examples described above (e.g., FIG. 1). The method 200 may comprise one or more additional optional features corresponding to one or more aspects of the proposed technique or one or more examples described above.

The following examples pertain to further embodiments:

An apparatus for inducing motion perception, the apparatus comprising processing circuitry configured to:
receive data indicating a target motion to be perceived by a user; and
control an object to change a physical property of the object based on the target motion to induce perception of the target motion by the user, wherein the object is arranged for interaction with the user.

The apparatus of (1), wherein the physical property is a stiffness of a surface of the object.

The apparatus of (2), wherein, for controlling the object to change the stiffness of the surface of the object, the processing circuitry is configured to control the object to change a pressure in a volume mechanically coupled to the surface of the object.

(4) The apparatus of (2) or (3), wherein the target motion is falling or tilting, wherein the object is a chair, and wherein the processing circuitry is configured to control the chair to reduce a stiffness of at least one armrest thereof.

The apparatus of (2) or (3), wherein the target motion is acceleration or deceleration, wherein the object is a chair, and wherein the processing circuitry is configured to control the chair to change a stiffness of a backrest thereof.

The apparatus of (1), wherein the object is a pair of shoes, and wherein the physical property is a property of the pair of shoes.

The apparatus of (6), wherein, for controlling the pair of shoes to change the property of the pair of shoes, the processing circuitry is configured to control at least one shoe of the pair of shoes to change a respective pressure in one or more volumes of the respective shoe.

The apparatus of (6) or (7), wherein the target motion is stumbling, and wherein the processing circuitry is configured to control the pair of shoes to reduce the stiffness of soles of the pair of shoes.

(9) The apparatus of (6) or (7), wherein the target motion is falling or tilting, and wherein the processing circuitry is configured to control the pair of shoes to reduce the stiffness of a sole of at least one shoe of the pair of shoes.

The apparatus of (6) or (7), wherein the target motion is moving forward or backward, and wherein the processing circuitry is configured to control the pair of shoes to change an inclination of soles of the pair of shoes.

The apparatus of (1), wherein the object is a game controller, and wherein the physical property is a property of the game controller.

The apparatus of (11), wherein the processing circuitry is configured to control the game controller to change a center of mass of the game controller in accordance with the target motion.

(13) The apparatus of (12), wherein, for controlling the game controller to change the center of mass of the game controller, the processing circuitry is configured to control a motor of the game controller to change a position of a movable mass of the game controller in accordance with the target motion.

(14) The apparatus of (11), wherein the processing circuitry is configured to control the game controller to change a color of the game controller in accordance with the target motion.

(15) The apparatus of (11), wherein the processing circuitry is configured to control the game controller to display a representation of feet of the user, wherein a movement of the feet is in accordance with the target motion.

(16) A method for inducing motion perception, the method comprising: receiving data indicating a target motion to be perceived by a user; and
controlling an object to change a physical property of the object based on the target motion to induce perception of the target motion by the user, wherein the object is arranged for interaction with the user.

(17) A non-transitory machine-readable medium having stored thereon a program having a program code for performing the method according to (16), when the program is executed on a processor or a programmable hardware.

(18) A program having a program code for performing the method according to (16), when the program is executed on a processor or a programmable hardware.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-processor computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), ASICs, integrated circuits (ICs) or SoCs programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps,-functions,-processes or-operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for inducing motion perception, the apparatus comprising processing circuitry configured to:
receive data indicating a target motion to be perceived by a user; and
control an object to change a physical property of the object based on the target motion to induce perception of the target motion by the user, wherein the object is arranged for interaction with the user.

2. The apparatus of claim 1, wherein the physical property is a stiffness of a surface of the object.

3. The apparatus of claim 2, wherein, for controlling the object to change the stiffness of the surface of the object, the processing circuitry is configured to control the object to change a pressure in a volume mechanically coupled to the surface of the object.

4. The apparatus of claim 2, wherein the target motion is falling or tilting, wherein the object is a chair, and wherein the processing circuitry is configured to control the chair to reduce a stiffness of at least one armrest thereof.

5. The apparatus of claim 2, wherein the target motion is acceleration or deceleration wherein the object is a chair, and wherein the processing circuitry is configured to control the chair to change a stiffness of a backrest thereof.

6. The apparatus of claim 1, wherein the object is a pair of shoes, and wherein the physical property is a property of the pair of shoes.

7. The apparatus of claim 6, wherein, for controlling the pair of shoes to change the property of the pair of shoes, the processing circuitry is configured to control at least one shoe of the pair of shoes to change a respective pressure in one or more volumes of the respective shoe.

8. The apparatus of claim 6, wherein the target motion is stumbling, and wherein the processing circuitry is configured to control the pair of shoes to reduce the stiffness of soles of the pair of shoes.

9. The apparatus of claim 6, wherein the target motion is falling or tilting, and wherein the processing circuitry is configured to control the pair of shoes to reduce the stiffness of a sole of at least one shoe of the pair of shoes.

10. The apparatus of claim 6, wherein the target motion is moving forward or backward, and wherein the processing circuitry is configured to control the pair of shoes to change an inclination of soles of the pair of shoes.

11. The apparatus of claim 1, wherein the object is a game controller, and wherein the physical property is a property of the game controller.

12. The apparatus of claim 11, wherein the processing circuitry is configured to control the game controller to change a center of mass of the game controller in accordance with the target motion.

13. The apparatus of claim 12, wherein, for controlling the game controller to change the center of mass of the game controller, the processing circuitry is configured to control a motor of the game controller to change a position of a movable mass of the game controller in accordance with the target motion.

14. The apparatus of claim 11, wherein the processing circuitry is configured to control the game controller to change a color of the game controller in accordance with the target motion.

15. The apparatus of claim 11, wherein the processing circuitry is configured to control the game controller to display a representation of feet of the user, wherein a movement of the feet is in accordance with the target motion.

16. A method for inducing motion perception, the method comprising:
receiving data indicating a target motion to be perceived by a user; and
controlling an object to change a physical property of the object based on the target motion to induce perception of the target motion by the user, wherein the object is arranged for interaction with the user.

17. A non-transitory machine-readable medium having stored thereon a program having a program code for performing the method according to claim 16, when the program is executed on a processor or a programmable hardware.
